(19) United States
(12) Patent Application Publication
(10) Pub. No.: US 2008/0292950 A1
(43) Pub. Date: Nov. 27, 2008

(54) BATTERY MODULE

(75) Inventors: Hitoshi Maeda, Moriguchi-shi (JP); Masayuki Fujiwara, Moriguchi-shi (JP); Yoshitaka Shinyashiki, Moriguchi-shi (JP); Atsuhiro Funahashi, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/127,361

(22) Filed: May 27, 2008

(30) Foreign Application Priority Data
May 24, 2007 (JP) 2007-137493
Mar. 31, 2008 (JP) 2008-093526

(51) Int. Cl. H01M 2/14; H01M 10/50; H01M 6/42

(52) U.S. Cl. 429/120; 429/149; 429/247

(57) ABSTRACT

A spacer (52) interposed between a plurality of batteries in a battery module has an inner cavity. A filling agent having fire-extinguishing capability is filled in the inner cavity. An opening can be formed at a portion (low-melting point portion (14)) of the spacer (52) by heat so that the filling agent can flow out of the spacer.

### BACKGROUND OF THE INVENTION

1. Field of the Invention

The present invention relates to a battery module comprising a plurality of batteries, and more particularly to a battery module that is lightweight and safe, and shows high load characteristics and high reliability.

2. Description of Related Art

Power sources that are incorporated in robots and electric automobiles, for example, are required to be lightweight and small in size, as well as being low cost, because they are enclosed in a limited space. Lithium-ion batteries, which have high energy density, have attracted attention as a battery that meets such requirements. In order to obtain high power, the lithium-ion batteries are used to form a battery module, which contains a large number of the lithium-ion batteries, typically from several cells to over 10 cells, connected in series or in parallel.

During charging and discharging of the lithium-ion batteries, the battery temperature may rise. If the battery module is configured in such a manner that the side faces of the cells are in close contact with each other, the heat cannot dissipate from the batteries sufficiently, and the battery temperature further rises, which may consequently cause the batteries to ignite or explode.

In a known technique, spacers made of metal are inserted between the adjacent batteries to increase the contact area between the atmosphere and the batteries so that the heat dissipation capability of the batteries can be improved. In this technique, however, the battery module using such spacers shows poor mass energy density because the spacer made of metal has a large specific gravity.

In contrast, when a spacer made of plastic or rubber is used, the spacer made of plastic or rubber does not degrade the energy density of the battery module as much as the spacer made of metal does. However, the spacer may catch fire if a portion of the battery module ignites, and as a consequence, spreading of fire occurs in the battery module.

In view of the problems, Japanese Published Unexamined Patent Application No. 2000-67825 discloses a battery module in which the spread of fire of the batteries is prevented without degrading the energy density of the battery module by forming the spacers from a material that contains a substance having at least either flame-retardant capability or self-extinguishing capability.

Japanese Published Unexamined Patent Application No. 8-339823 discloses a battery module in which a plurality of batteries are accommodated in a flat manner in a heat insulative container, and an insulative material such as dry sand is filled in an upper space of the container. The module is configured so that when the batteries are greatly damaged, the heat produced at that time causes the dry sand or the like in the upper space to fall down over the battery main unit in the lower space so as to extinguish fire.

Japanese Published Unexamined Patent Application No. 2006-261009 discloses a battery pack in which paraffin is filled in a gap between the secondary batteries contained in a battery case and in a gap between the inner wall of the battery case and the secondary batteries. In this battery pack, latent heat absorption at the time when paraffin melts can prevent the batteries from being heated above the temperature at which the batteries deteriorate.

In the case of using the spacer having a configuration with flame-retardant capability or self-extinguishing capability, as disclosed in JP 2000-67825A, the spacer does not have fire-extinguishing capability, although spreading of fire in the battery may be prevented. For this reason, once a battery catches fire, the fire does not go out and it continues to burn.

On the other hand, in the case of employing the configuration in which dry sand or paraffin is filled in a space inside the module or the battery case, as disclosed in Japanese Published Unexamined Patent Application Nos. 8-339823 and 2006-261009, the volume of the module or the battery case increases corresponding to the space in which the dry sand or paraffin is filled. As a consequence, the problem of poor volumetric energy density of the battery module arises.

Accordingly, it is an object of the present invention to provide a battery module that can prevent the batteries from temperature elevation and spreading of fire effectively, that can also extinguish the fire in a battery in which ignition has occurred, and that can be configured to be compact and have a high volumetric energy density.

### BRIEF SUMMARY OF THE INVENTION

In order to accomplish the foregoing and other objects, the present invention provides a battery module comprising: a plurality of batteries connected in series or in parallel, and at least one spacer, for heat insulation and/or heat release, interposed between the plurality of batteries; and a filling agent filled in an inner cavity provided in the at least one spacer, the filling agent having fire-extinguishing capability, wherein an opening can be formed in at least a portion of the at least one spacer by heat so that the filling agent can flow out therethrough.

In the present invention, the at least one spacer interposed between the plurality of batteries in the battery module has an inner cavity, a filling agent having fire-extinguishing capability is filled in the inner cavity, and an opening can be formed at least a portion of the spacer by heat so that the filling agent can flow out of the spacer. Therefore, when the battery temperature rises, the heat is insulated and/or dissipated by the spacer in which the filling agent is filled in the inner cavity, so the battery temperature is prevented from rising further. Moreover, after an opening is formed in at least a portion of the spacer and the filling agent flows out, the inner cavity of the spacer is emptied and an air space is formed. This air space makes the heat insulation more effective, and therefore, even if abnormal heat generation occurs in one of the plurality of batteries, the abnormal heat generation is prevented from spreading to other batteries reliably. Furthermore, even if one of the plurality of batteries ignites, the spacer, in which the filling agent having fire-extinguishing capability is filled, can prevent spreading of the fire because the filling agent has fire-extinguishing capability. Sill further, when this happens, the filling agent having fire-extinguishing capability flows out and scatters over the portion that has ignited, whereby the fire is extinguished.

Furthermore, because the spacer has an inner cavity, the spacer is lightweight even when the spacer is made of metal. When the spacer is made of plastic or rubber, the spacer can be made further lightweight. Thus, the energy density of the battery module does not degrade. In addition, because the filling agent having fire-extinguishing capability is filled in the spacer, it is unnecessary to allocate a space for the filling agent outside the spacer. Therefore, the battery module can be configured to be compact correspondingly, and the volumetric energy density can be made large.

Thus, the present invention makes it possible to provide a battery module that can prevent batteries from temperature elevation or spreading of fire effectively, that can also extinguish the fire in a battery in which ignition has occurred, and that can be configured to be compact and have a high volumetric energy density.

### BRIEF DESCRIPTION OF THE DRAWINGS

FIG. 1 is a plan view illustrating a positive electrode used for a battery (cell) in a battery module according to the present invention;

FIG. 2 is a plan view illustrating a negative electrode used for a battery (cell) in the battery module according to the present invention;

FIG. 3 is a perspective view illustrating a separator used for a battery (cell) in the battery module according to the present invention;

FIG. 4 is a plan view illustrating a positive electrode, in which the positive electrode shown in FIG. 1 is enclosed in the separator shown in FIG. 3;

FIG. 5 is an exploded perspective view illustrating a stacked electrode assembly used for a battery (cell) in the battery module according to the present invention;

FIG. 6 is a side view illustrating the stacked electrode assembly used for a battery (cell) in the battery module according to the present invention;

FIG. 7 is a perspective view illustrating the stacked electrode assembly shown in FIG. 6 inserted in a battery case used for a battery (cell) in the battery module according to the present invention;

FIG. 8 is a perspective view illustrating one example of a spacer comprised in the battery module of the present invention;

FIG. 9 is a perspective view illustrating another example of a spacer comprised in the battery module of the present invention;

FIG. 10 is a schematic side view illustrating one example of the battery module of the present invention;

FIG. 11 is an exploded perspective view illustrating yet another example of a spacer comprised in the battery module of the present invention;

FIG. 12 is a perspective view illustrating the spacer shown in FIG. 11;

FIG. 13 is a perspective view illustrating one example of a battery (cell) comprised in the battery module of the present invention;

FIG. 14 is a perspective view illustrating the battery (cell) shown in FIG. 13 that is placed in the spacer shown in FIG. 12;

FIG. 15 is a schematic side view illustrating another example of the battery module of the present invention;

FIG. 16 is a perspective view illustrating the battery module shown in FIG. 15;

FIG. 17 is a partially enlarged perspective view illustrating still another example of a spacer comprised in the battery module of the present invention;

FIG. 18 is a partially enlarged perspective view illustrating further another example of a spacer comprised in the battery module of the present invention;

FIG. 19 is a perspective view illustrating one example of a battery (cell) comprised in the battery module of the present invention, on which heat conductive material layers have not yet been formed;

FIG. 20 is a perspective view illustrating the battery (cell) shown in FIG. 19, on which the heat conductive material layers have been formed; and

FIG. 21 is a schematic side view illustrating a battery module employing the battery (cell) shown in FIG. 19.

### DETAILED DESCRIPTION OF THE INVENTION

A battery module according to the invention comprises: a plurality of batteries connected in series or in parallel, and at least one spacer, for heat insulation and/or heat release, interposed between the plurality of batteries; and a filling agent filled in an inner cavity provided in the at least one spacer, the filling agent having fire-extinguishing capability, wherein an opening can be formed in at least a portion of the at least one spacer by heat so that the filling agent can flow out therethrough.

According to the above-described configuration, if the battery temperature rises under a normal battery use condition, heat insulation and/or heat release is/are performed by the spacer, in which the filling agent is filled in the inner cavity, so that a further increase of the battery temperature can be prevented. Moreover, even when abnormal heat generation occurs in one of the plurality of batteries, an opening is formed in at least a portion of the spacer by the heat and the filling agent flows out of the spacer. Thereby, the inner cavity of the spacer is emptied and an air space is formed. By this air space, heat insulation is performed more effectively, and the abnormal heat generation is reliably prevented from spreading to other batteries. Furthermore, even if one of the plurality of batteries ignites, the spacer in which the filling agent having fire-extinguishing capability is filled can prevent spreading of the fire because the filling agent has fire-extinguishing capability. In addition, when this happens, the filling agent having fire-extinguishing capability flows out and scatters over the portion that has ignited, whereby the fire is extinguished.

Furthermore, because the spacer has an inner cavity, the spacer is lightweight even when the spacer is made of metal. When the spacer is made of plastic or rubber, the spacer can be made further lightweight. Thus, the mass energy density of the battery module does not degrade.

In addition, because the filling agent having fire-extinguishing capability is filled in the spacer, it is unnecessary to allocate a space for the filling agent outside the spacer. Therefore, the battery module can be configured to be compact correspondingly, and the volumetric energy density can be made large.

It should be noted that examples of the filling agent having fire-extinguishing capability include, in addition to commonly used fire extinguishing agents such as ammonium dihydrogen phosphate, which will be mentioned later, non-flammable liquids such as water, non-flammable gases such as carbonic acid gas, and non-flammable powder materials.

The at least one spacer may be made of a flammable plastic.

The present invention employs a configuration in which the filling agent having fire-extinguishing capability is filled in the spacer. Therefore, even when the spacer is made of a flammable plastic, the filling agent can prevent spreading of fire. Rather, by making the spacer from a flammable plastic, the spacer can be burnt when ignition occurs so that the filling agent therein can flows out therefrom, and the fire can be extinguished by the filling agent. Moreover, it is possible to use a common plastic such as polyethylene or polypropylene as the flammable plastic. As a result, the spacer can be fabricated at low cost, and good processability is obtained.

It is desirable that a portion of the at least one spacer have a low-melting point portion made of a material having a melting point lower than a melting point of a material that constitutes the at least one spacer.

For example, when the spacer is made of polyethylene (PE), polypropylene (PP) or polyethylene terephthalate (PET), a low-melting point portion made of a low-melting point material such as a metal having a melting point lower than the melting points of these material, for example, about less than 150° C., more preferably about 70° C. to 80° C., is formed in a portion of the spacer, since the melting points of these materials are about 105° C. to 150° C. for PE, about 150° C. to 180° C. for PP, and about 250° C. to 280° C. for PET. Thereby, when the battery generates heat and the temperature rises to about 70° C. to 150° C., the low-melting point portion melts, forming an opening, and the filling agent in the spacer flows out. Thus, a spacer that is capable of forming an opening by heat and allowing the filling agent therein to flow out can be obtained with a simple configuration of forming a low-melting point portion at a portion of the spacer. Moreover, by appropriately selecting the location where the low-melting point portion is to be formed, the location from which the filling agent flows out can be controlled at a desired location.

If the melting point of the low-melting point portion is excessively low, the formation of the opening in the low-melting point portion occurs, causing the filling agent to flow out, at the stage where the battery has not yet caused abnormal heat generation but is in a normal use condition. On the other hand, if the melting point of the low-melting point portion is excessively high, the filling agent may fail to flow out even when abnormal heat generation occurs, and consequently, failure in heat insulation and fire-extinguishing may result. For this reason, it is desirable that the melting point of the low-melting point portion be from 70° C. to 150° C., and more preferably from 100° C. to 120° C.

Examples of the metal that may be used for forming the low-melting point portion include the alloys listed in Table I below.

TABLE 1

| Low-melting | | | | | | | | | Melting range | |
|---|---|---|---|---|---|---|---|---|---|---|
| point alloy | Composition | | | | | | | Density | Solidus | Liquidus |
| No. | Sn | Bi | Pb | Cd | In | Zn | Other | (g/cm³) | (° C.) | (° C.) |
| 1 | 92.00 | 0.00 | 0.00 | 0.00 | 0.00 | 8.00 | 0.00 | 7.29 | 199 | 199 |
| 2 | 62.00 | 0.00 | 38.00 | 0.00 | 0.00 | 0.00 | 0.00 | 9.84 | 183 | 183 |
| 3 | 67.00 | 0.00 | 0.00 | 33.00 | 0.00 | 0.00 | 0.00 | 7.75 | 176 | 176 |
| 4 | 40.00 | 0.00 | 42.00 | 18.00 | 0.00 | 0.00 | 0.00 | 9.25 | 145 | 160 |
| 5 | 51.20 | 0.00 | 30.60 | 18.20 | 0.00 | 0.00 | 0.00 | 8.79 | 145 | 145 |
| 6 | 0.00 | 60.00 | 0.00 | 40.00 | 0.00 | 0.00 | 0.00 | 9.34 | 144 | 144 |
| 7 | 48.00 | 16.00 | 36.00 | 0.00 | 0.00 | 0.00 | 0.00 | 9.16 | 140 | 168 |
| 8 | 48.80 | 10.20 | 41.00 | 0.00 | 0.00 | 0.00 | 0.00 | 9.22 | 142 | 166 |
| 9 | 43.00 | 57.00 | 0.00 | 0.00 | 0.00 | 0.00 | 0.00 | 8.72 | 138 | 138 |
| 10 | 42.00 | 58.00 | 0.00 | 0.00 | 0.00 | 0.00 | 0.00 | 8.75 | 138 | 138 |
| 11 | 41.60 | 57.40 | 1.00 | 0.00 | 0.00 | 0.00 | 0.00 | 8.78 | 134 | 135 |
| 12 | 40.00 | 56.00 | 0.00 | 0.00 | 0.00 | 4.00 | 0.00 | 8.69 | 130 | 130 |
| 13 | 0.00 | 55.50 | 44.50 | 0.00 | 0.00 | 0.00 | 0.00 | 10.27 | 124 | 124 |
| 14 | 48.00 | 0.00 | 0.00 | 0.00 | 52.00 | 0.00 | 0.00 | 7.31 | 117 | 117 |
| 15 | 1.00 | 55.00 | 44.00 | 0.00 | 0.00 | 0.00 | 0.00 | 10.46 | 117 | 120 |
| 16 | 25.90 | 53.90 | 0.00 | 20.20 | 0.00 | 0.00 | 0.00 | 9.90 | 103 | 103 |
| 17 | 34.20 | 46.10 | 19.70 | 0.00 | 0.00 | 0.00 | 0.00 | 9.25 | 96 | 123 |
| 18 | 22.00 | 50.00 | 28.00 | 0.00 | 0.00 | 0.00 | 0.00 | 9.69 | 96 | 100 |
| 19A | 20.00 | 50.00 | 30.00 | 0.00 | 0.00 | 0.00 | 0.00 | 9.77 | 96 | 100 |
| 19B | 15.50 | 52.50 | 32.00 | 0.00 | 0.00 | 0.00 | 0.00 | | 96 | 96 |
| 19C | 17.30 | 57.50 | 0.00 | 0.00 | 25.20 | 0.00 | 0.00 | | 78.8 | 78.8 |
| 20 | 11.30 | 42.50 | 37.70 | 8.50 | 0.00 | 0.00 | 0.00 | 9.44 | 70 | 90 |
| 21 | 13.30 | 50.00 | 26.70 | 10.00 | 0.00 | 0.00 | 0.00 | 9.38 | 70 | 73 |
| 22 | 12.50 | 50.00 | 25.00 | 12.50 | 0.00 | 0.00 | 0.00 | 9.73 | 70 | 72 |
| 23A | 12.77 | 48.00 | 25.63 | 9.60 | 4.00 | 0.00 | 0.00 | 9.46 | 61 | 65 |
| 23B | 19.00 | 53.50 | 17.00 | 0.00 | 10.50 | 0.00 | 0.00 | | 60 | 60 |
| 24 | 12.00 | 49.00 | 18.00 | 0.00 | 21.00 | 0.00 | 0.00 | 8.57 | 58 | 58 |
| 25 | 8.30 | 44.70 | 22.60 | 5.30 | 19.10 | 0.00 | 0.00 | 8.86 | 47 | 47 |

All of alloys 1 through 25 listed in Table I may be used as a metal that constitutes the low-melting point portion. Among them, alloys 4 through 22 are desirable from the viewpoint of melting temperature.

When the spacer is made of a plastic having a relatively high melting point, such as PET (melting point: about 250° C. to 280° C.), it is possible to form the low-melting point portion with a plastic having a melting point lower than that. Examples of the plastics for forming the low-melting point portion include thermoplastic fluororesin having a melting point of 120° C. or higher (such as Dyneon made by Sumitomo 3M Ltd.) and low-density polyethylene having a melting point of 110° C. or higher (such as Sunfine made by Asahi Kasei Corp.).

By forming the low-melting point portion also by a plastic, the battery module can be formed to be more lightweight and low in cost.

It is desirable that the at least one low-melting point portion be a plurality of low-melting point portions, and the plurality of low-melting point portions be formed at a plurality of locations located at different height positions.

With the above-described configuration, an upper low-melting point portion allows the filling agent filled at a position higher than that to flow outside therethrough and flow downward, whereby the primary fire extinguishing process (initial stage fire-extinguishing) is performed at the portion lower than the upper low-melting point portion. Subsequently, a lower low-melting point portion allows the remaining filling agent to flow outside, whereby the secondary fire extinguishing process is performed. Thus, the filling agent is allowed to flow out at a plurality of height positions in this way in performing the fire extinguishing, so the fire extinguishing can be performed more effectively.

In particular, it is believed that abnormal heat generation or ignition occurs most easily at the central portion of the battery. For this reason, by forming a low-melting point portion at least at a higher position than the central portion so that the filling agent can flow out to the central portion, the fire extinguishing can be performed more efficiently.

It should be noted that in this case, the filling agent is allowed to flow out successively from an upper low-melting point portion by setting the melting point of the upper low-melting point portion to be lower than that of a lower low-melting point portion.

It is desirable that the battery module further comprises a drip pan for collecting the filling agent flowing out from the at least one spacer.

This configuration makes the fire extinguishing by the filling agent more effective. Specifically, fire extinguishing is performed on the way in which the filling agent flows out of the spacer and moreover the battery is immersed in the filling agent collected by the drip pan, which makes the fire extinguishing more reliable. Furthermore, the drip pan also serves the function to prevent the filling agent that has flowed out from leaking out of the battery module.

It is desirable that the drip pan be divided into a plurality of sections.

In the above-described configuration, the drip pan is not configured to be provided for the entirety of the plurality of batteries and the spacers forming the battery module, but rather, the plurality of divided sections of the drip pan are provided, for example, respectively for the members of the battery module that are grouped into small portions. As a result, if ignition occurs in any of the plurality of batteries forming the battery module, for example, the filling agent is gathered intensively to the divided portion of the drip pan provided correspondingly to the ignited battery. Thus, the battery that has caused the ignition is immersed in the filling agent further (in other words, more deeply), so the fire extinguishing becomes more efficient.

In this case, the divided portion of the drip pan may be provided for every several units of the plurality of batteries forming the battery module, but it is more desirable that the divided portion be provided respectively for every one of the batteries.

It is desirable that the at least one spacer comprise ribs extending vertically and formed on a surface of the at least one spacer that is in contact with one of the plurality of batteries.

In the above-described configuration, gaps are formed along both sides of each rib, and the gaps serve as the passage for the filling agent, allowing the filling agent to flow downward more reliably. Moreover, the gaps serve as heat dissipation paths in the event that heat generation occurs in a battery, whereby heat release is performed more effectively. In particular, since batteries are in contact with both surfaces of the spacer, the filling agent can flow downward more easily and heat release is also more effective when the batteries are in contact with the spacer with the ribs formed thereon than when both surfaces of the spacer are flat and smooth and the spacer and the batteries are in close contact with each other entirely.

It is desirable that the at least one spacer have flexibility such that it can shrink when in a compressed state, and that the at least one spacer form at least a portion of a pouch-type container in which one of the plurality of batteries is placed.

In the above-described configuration, when an opening forms in the spacer, the spacer shrinks by the pressure so as to squeeze out the filling agent therefrom, allowing the filling agent to flow out therefrom effectively. In addition, the shrinkage of the spacer produces crease-like surface irregularities, and the surface irregularities can serve the function similar to that of the above-described rib. Moreover, because the spacer forms at least a portion of the pouch-type container in which one of the cells can be placed, the pouch-type container can also serve as a drip pan for collecting the filling agent that has flowed out of the spacer. Thereby, fire extinguishing is performed more effectively. More specifically, the filling agent that has flowed out of the spacer is reserved in the interior of the pouch-type container, so the battery is immersed in the reserved filling agent more reliably, whereby fire extinguishing is performed more effectively.

It is desirable that a heat conductive material layer be formed between the at least one spacer and a battery.

In the above-described configuration, heat conduction from the battery to the spacer is promoted and heat release is performed more efficiently since the heat conductive material layer is interposed between the spacer and the battery. Thereby, the battery deterioration resulting from temperature increase is prevented.

When each battery is enclosed in a battery case, especially when the battery is enclosed in a battery case having flexibility such as a laminate film, the surface of the battery case tends to be damaged easily during the assembling process of the battery module, for example, by scratches or the like caused by mechanical impacts associated with the assembling process. The above-described heat conductive material layer additionally has the advantageous effect of protecting the battery from the mechanical impacts or the like and preventing the damages.

It is desirable that the heat conductive material layer comprise a gel material.

The heat conductive material layer may be formed of a material showing good heat conductivity, such as metal and carbon fiber. However, for example, if a gap forms between the spacer and the battery, it is possible that the heat conductivity may be impaired by the resulting air space. In contrast, when the heat conductive material layer is formed of a gel material, the heat conductive material layer is provided with good adhesion with the spacer and the battery, and therefore, the air space does not form easily. As a result, heat conduction becomes more effective, and the heat dissipation capability further improves. In addition, the battery is protected more reliably from mechanical impacts or the like. Especially when the battery is enclosed in a battery case having flexibility, such as a laminate film, the battery tends to easily deform when handling, and in addition, the battery deforms to a certain degree due to the volumetric change resulting from the charge-discharge operations. However, when the heat conductive material layer is formed of a gel material, it can change the shape correspondingly to such deformation of the battery. Accordingly, the heat conductive material layer can be formed easily, and moreover, cracks resulting from the battery deformation can be prevented.

It is desirable that the heat conductive material layer be formed of a gel sheet.

When forming the heat conductive material layer from a gel material as described above, it is possible to form the heat conductive material layer by, for example, coating the surfaces of the spacer and the battery with a paste made of the gel material. However, when the heat conductive material layer is made of a gel sheet, handling becomes easy, and the heat conductive material layer can be formed by merely inserting the sheet between the spacer and the battery. As a result, the workability in the process of fabricating the battery module is improved.

It is desirable that the heat conductive material layer comprise silicone.

Although the substance for forming the heat conductive material layer is not particularly limited as long as the substance achieves required heat conductivity, the material comprising silicone as the main component has good heat conductivity and tends to be available easily at low cost.

It is desirable that the heat conductive material layer have a thermal conductivity of from 6 W/m·K to 10 W/m·K.

By controlling the thermal conductivity of the heat conductive material layer to be 6 W/m·K or higher, heat conduction is performed sufficiently by the heat conductive material layer, enhancing the heat dissipation effect. On the other hand, the thermal conductivity range to be 10 W/m·K or less is that in which the heat conductive material layer can be easily formed.

It is desirable that the heat conductive material layer have a thickness of from 0.5 mm to 3 mm.

When the thickness of the heat conductive material layer is 0.5 mm or greater, the characteristics of the heat conductive material layer, such as heat conductivity and impact resistance, can be ensured sufficiently. When the thickness of the heat conductive material layer is 3 mm or less, the heat conductive material layer does not occupy too much space, preventing the volumetric energy density of the battery from reducing, and also, deterioration of the heat conductivity does not occur since the heat conductive material layer is not excessively thick.

The present invention also provides a battery module comprising: a plurality of batteries connected in series or in parallel, and at least one spacer for heat insulation and/or heat release interposed between the plurality of batteries; and a heat conductive material layer formed between the at least one spacer and at least one of the plurality of batteries.

In the battery module with the above-described configuration (hereinafter also referred to as a “second battery module”), heat conduction from the battery to the spacer is promoted and heat release is performed more efficiently since the heat conductive material layer is interposed between the spacer and the battery. Thereby, the battery deterioration resulting from temperature increase is prevented.

When each battery is enclosed in a battery case, especially when the battery is enclosed in a battery case having flexibility such as a laminate film, the surface of the battery case tends to be damaged easily during the assembling process of the battery module, for example, by scratches or the like caused by mechanical impacts associated with the assembling process. The above-described heat conductive material layer additionally has the advantageous effect of protecting the battery from the mechanical impacts or the like and preventing the damages.

In the battery module according to the second aspect, it is desirable that the heat conductive material layer comprise a gel material.

The heat conductive material layer may be formed of a material showing good heat conductivity, such as metal and carbon fiber. However, for example, if a gap forms between the spacer and the battery, it is possible that the heat conductivity may be impaired by the resulting air space. In contrast, when the heat conductive material layer is formed of a gel material, the heat conductive material layer is provided with good adhesion with the spacer and the battery, and therefore, the air space does not form easily. As a result, heat conduction becomes more effective, and the heat dissipation capability further improves. In addition, the battery is protected more reliably from mechanical impacts or the like. Especially when the battery is enclosed in a battery case having flexibility, such as a laminate film, the battery tends to easily deform when handling, and in addition, the battery deforms to a certain degree due to the volumetric change resulting from the charge-discharge operations. However, when the heat conductive material layer is formed of a gel material, it can change the shape correspondingly to such deformation of the battery. Accordingly, the heat conductive material layer can be formed easily, and moreover, cracks resulting from the battery deformation can be prevented.

In the battery module according to the second aspect, it is desirable that the heat conductive material layer be formed of a gel sheet.

When forming the heat conductive material layer from a gel material as described above, it is possible to form the heat conductive material layer by, for example, coating the surfaces of the spacer and the battery with a paste made of the gel material. However, when the heat conductive material layer is made of a gel sheet, handling becomes easy, and the heat conductive material layer can be formed by merely inserting the sheet between the spacer and the battery. As a result, the workability in the process of fabricating the battery module is improved.

In the battery module according to the second aspect, it is desirable that the heat conductive material layer comprise silicone.

Although the substance for forming the heat conductive material layer is not particularly limited as long as the substance achieves required heat conductivity, the material comprising silicone as the main component has good heat conductivity and tends to be available easily at low cost.

In the battery module according to the second aspect, it is desirable that the heat conductive material layer have a thermal conductivity of from 6 W/m·K to 10 W/m·K.

By controlling the thermal conductivity of the heat conductive material layer to be 6 W/m·K or higher, heat conduction is performed sufficiently by the heat conductive material layer, enhancing the heat dissipation effect. On the other hand, the thermal conductivity range to be 10 W/m·K or less is that in which the heat conductive material layer can be easily formed.

In the battery module according to the second aspect, it is desirable that the heat conductive material layer have a thickness of from 0.5 mm to 3 mm.

When the thickness of the heat conductive material layer is 0.5 mm or greater, the characteristics of the heat conductive material layer, such as heat conductivity and impact resistance, can be ensured sufficiently. When the thickness of the heat conductive material layer is 3 mm or less, the heat conductive material layer does not occupy too much space, preventing the volumetric energy density of the battery from reducing, and also, deterioration of the heat conductivity does not occur since the heat conductive material layer is not excessively thick.

A secondary battery according to the present invention is a secondary battery enclosed in a battery case having flexibility, wherein a heat conductive material layer made of a gel material is formed on a surface of the battery case.

With the above-described configuration, heat release from the battery is promoted because the heat conductive material layer formed of a gel material is formed on the surface of the battery case. As a result, deterioration of the secondary battery originating from temperature increase can be prevented.

When the battery is enclosed in a battery case having flexibility such as that made of a laminate film, the surface of the battery case tends to be damaged easily by scratches or the like caused by mechanical impacts during shipping, use, handling and the like of the battery. The above-described heat conductive material layer additionally has the advantageous effect of protecting the battery from the mechanical impacts or the like and preventing the damages.

In addition, because the heat conductive material layer is formed of a gel material, the heat conductive material layer has good adhesion with the battery, and accordingly, the air space does not form easily. As a result, heat conduction from the battery becomes more effective, and the heat dissipation capability further improves. In addition, the battery is protected from mechanical impacts or the like more reliably. Since the battery is enclosed in a battery case having flexibility, the battery tends to easily deform when handling, and in addition, the battery deforms to a certain degree due to the volumetric change resulting from the charge-discharge operations. However, because the heat conductive material layer is formed of a gel material, it can change the shape correspondingly to such deformation of the battery. Therefore, the heat conductive material layer can be formed easily, and at the same time, cracks resulting from the battery deformation can be prevented.

In the above-described secondary battery, it is desirable that the heat conductive material layer be formed of a gel sheet.

The heat conductive material layer may be formed by, for example, coating the surfaces of the spacer and the battery with a paste made of the gel material. However, when the heat conductive material layer is made of a gel sheet, handling becomes easy, and the heat conductive material layer can be formed by merely attaching the sheet onto the surface of the battery case. As a result, the workability in the process of fabricating the battery module is improved.

In the above-described secondary battery, it is desirable that the heat conductive material layer comprise silicone.

Although the substance for forming the heat conductive material layer is not particularly limited as long as the substance achieves required heat conductivity, the material comprising silicone as the main component has good heat conductivity and tends to be available easily at low cost.

In the above-described secondary battery, it is desirable that the heat conductive material layer have a thermal conductivity of from 6 W/m·K to 10 W/m·K.

By controlling the thermal conductivity of the heat conductive material layer to be 6 W/m·K or higher, heat conduction is performed sufficiently by the heat conductive material layer, enhancing the heat dissipation effect. On the other hand, the thermal conductivity range to be 10 W/m·K or less is that in which the heat conductive material layer can be easily formed.

In the above-described secondary battery, it is desirable that the heat conductive material layer have a thickness of from 0.5 mm to 3 mm.

When the thickness of the heat conductive material layer is 0.5 mm or greater, the characteristics of the heat conductive material layer, such as heat conductivity and impact resistance, can be ensured sufficiently. When the thickness of the heat conductive material layer is 3 mm or less, the heat conductive material layer does not occupy too much space, preventing the volumetric energy density of the battery from reducing, and also, deterioration of the heat conductivity does not occur since the heat conductive material layer is not excessively thick.

### DESCRIPTION OF THE PREFERRED EMBODIMENTS

Hereinbelow, with reference to the drawings, the present invention is described in further detail based on certain embodiments and examples thereof. It should be construed, however, that the present invention is not limited to the following embodiments and examples, but various changes and modifications are possible without departing from the scope of the invention.

### Preparation of Positive Electrode

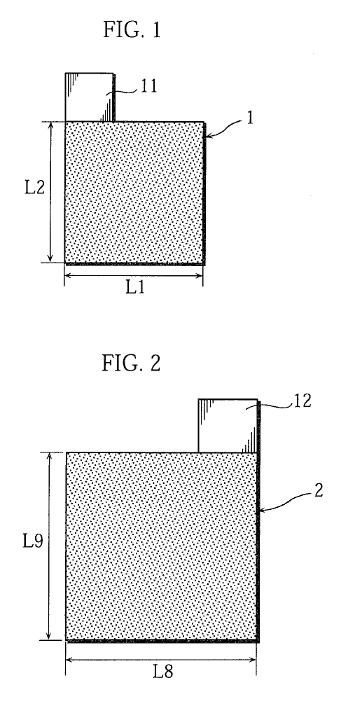

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector, except for the region to which a positive electrode current collector tab would be welded. Then, the material was dried to remove the solvent, pressure-rolled by rollers to a predetermined thickness (0.1 mm), and as illustrated in FIG. 1, cut into a shape that has predetermined width and height (width L1=95 mm, height L2=95 mm) and from which a positive electrode current collector tab 11 (a portion on which the positive electrode slurry was not applied) protrudes, to complete a positive electrode 1.

### Preparation of Negative Electrode

95 mass % of graphite powder as a negative electrode active material and 5 mass % of polyvinylidene fluoride as a binder agent were mixed with a NMP solution as a solvent to prepare a negative electrode mixture slurry. Thereafter, the resultant slurry was applied onto both sides of a copper foil (thickness: 10 μm) serving as a negative electrode current collector, except for the region to which a negative electrode current collector tab would be welded. Then, the material was dried to remove the solvent, pressure-rolled by rollers to a predetermined thickness, and as illustrated in FIG. 2, cut into a shape that has predetermined width and height (width L8=100 mm, height L9=100 mm, L1<L8, L2<L9) and from which a negative electrode current collector tab 12 (a portion on which the slurry was not applied) protrudes, to complete a negative electrode 2.

### Preparation of Positive Electrode Enclosed in Separator

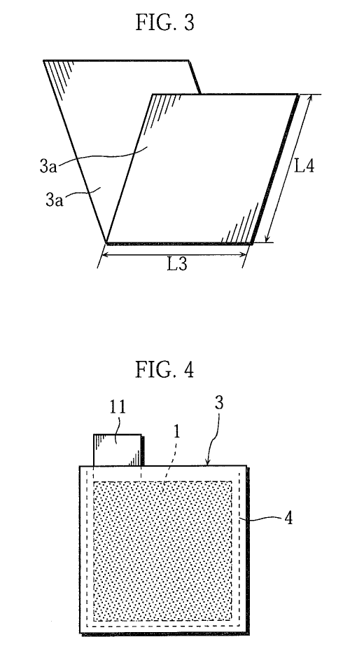

As illustrated in FIG. 3, two sheets of separators 3a made of polypropylene (PP), each of which was cut into the dimensions equal to those of the negative electrode 2 (width L3=L8=100 mm, height L4=L9=100 mm), were prepared. The positive electrode 1 was sandwiched by the separators 3a, and the perimeter portions of the separators 3 were thermally bonded at a bonding part 4, as illustrated in FIG. 4, so that the separators were formed into a bag.

### Preparation of Stacked Electrode Assembly

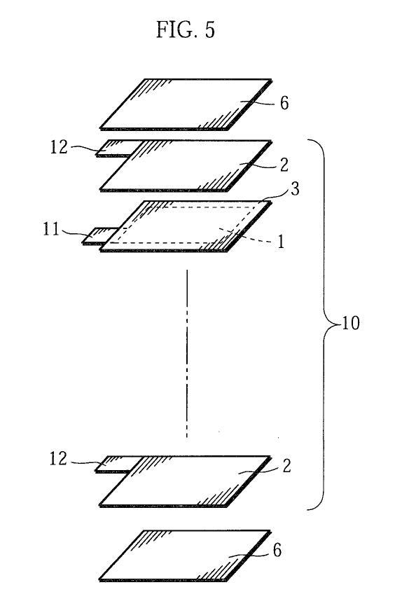

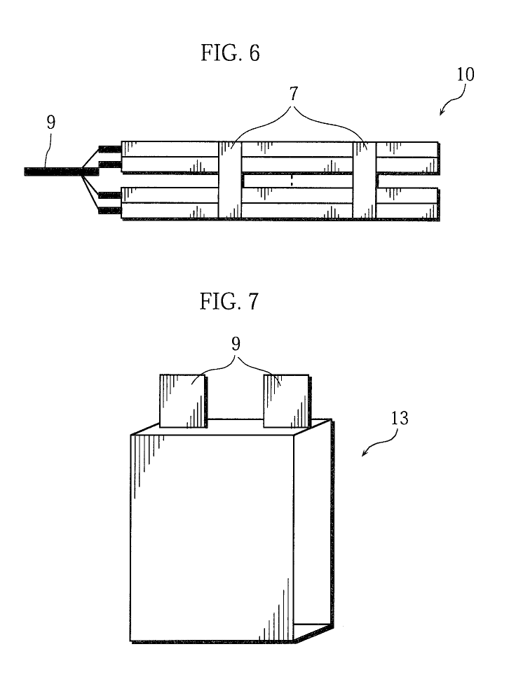

As illustrated in FIG. 5, 10 sheets of the positive electrodes 1, each of which was enclosed in a bag made of separator as described above, and 11 sheets of the negative electrodes 2 were prepared and laminated so that both end faces of the laminate were the negative electrodes 2. End face sheets 6 made of polypropylene were disposed on both end faces to retain the shape, and as illustrated in FIG. 6, both the end face sheets 6 were joined to each other by an insulating tape 7, to thus prepare a stacked electrode assembly 10. The thickness of the stacked electrode assembly 10 was 2.2 mm. Next, the positive electrode current collector tabs 11 and the negative electrode current collector tabs 12 were welded to respective current collector leads 9 by ultrasonic welding.

### Placing the Electrode Assembly in Battery Case

As illustrated in FIG. 7, the stacked electrode assembly 10 was inserted into in a battery case 13, which had been formed of two laminate films in advance so that the stacked electrode assembly 10 could be placed therein. Then, one side of the battery case in which the current collectors 9 are present was thermally bonded so that only the current collectors 9 (current collector leads) protrude outside, and of the remaining three sides, two sides were thermally bonded.

### Filling Electrolyte Solution and Sealing the Battery Case

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The resultant electrolyte solution was filled into the battery case 13 from the remaining one side of the battery case that was not yet thermally bonded. Lastly, the one side that had not been thermally bonded was thermally bonded, to thus prepare a lithium-ion battery (hereinafter referred to as a “cell”).

Preparation of Spacer in which Fire-Extinguishing Agent is Enclosed

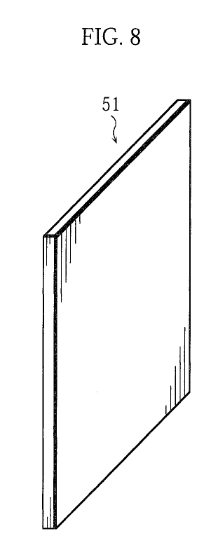

Plate materials made of polyethylene terephthalate (PET), each having a thickness of 1 mm, were bonded together to form a square-shaped pouch-type container, and ammonium dihydrogen phosphate (NH₄H₂PO₄, specific gravity: 1.74) was filled therein as a fire extinguishing agent. Lastly, the container was sealed by thermal bonding. Thus, as illustrated in FIG. 8, a spacer 51 (hereinafter referred to as a “A-type spacer”) was prepared, in which no low-melting point portion was formed and the fire extinguishing agent was enclosed. The spacer 51 had a width of 120 mm, a height of 150 mm, and a thickness of 5 mm.

### Preparation of Battery Module

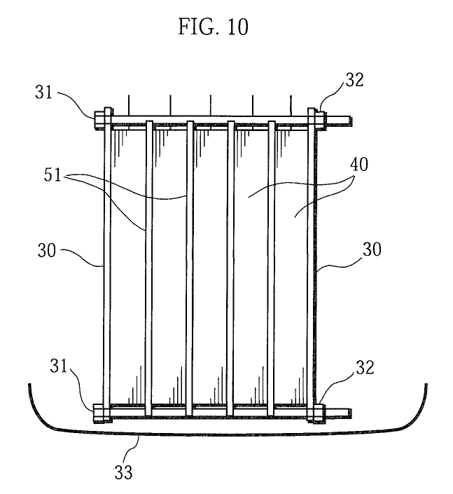

As illustrated in FIG. 10, five pieces of the cells 40 were stacked and four sheets of the A-type spacers 51 were interposed between the five pieces of the cells 40. These were disposed between two pressure plates 30, and the two pressure plates 30 were fastened by bolts 31 and nuts 32. Further, a drip pan 33 was attached therebelow. Thus, a battery module was prepared.

### EXAMPLES

### First Example

### Example A1

A battery module fabricated in the same manner as described in the foregoing embodiment was used as the battery module of Example A1.

The battery module thus fabricated is hereinafter referred to as a battery module A1.

### Example B1

A battery module was fabricated in the same manner as described in Example A1 above, except for using B-type spacers 52 that were prepared in the following manner, in place of the A-type spacers 51 used in Example 1.

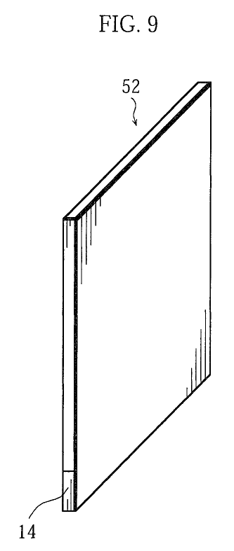

Plate materials made of polyethylene terephthalate (PET), each having a thickness of 1 mm, were bonded together to form a square-shaped pouch-type container, and water was filled therein as liquid. Lastly, a Bi—Cd—Pb—Sn alloy (with a mass ratio Bi:Cd:Pb:Sn=50:10:25:15 and a melting point of 75° C.) formed into a small piece with dimensions of 5 mm×10 mm×0.5 mm was bonded as a lid to one end of one peripheral edge of the pouch-type container, as illustrated in FIG. 9, to form a low-melting point portion 14. Thus, a spacer 52 (hereinafter referred to as a “B-type spacer”) in which liquid was enclosed was prepared. The spacer 52 had a width of 120 mm, a height of 150 mm, and a thickness of 5 mm.

The battery module fabricated in this manner is hereinafter referred to as a battery module B1.

### Advantageous Effects of Battery Module

The foregoing battery module A1 is configured as follows. Each of the A-type spacers 51, which are interposed between a plurality of cells (five cells) that form the battery module A1, has an inner cavity, and ammonium dihydrogen phosphate as a filling agent having fire-extinguishing capability is filled in the inner cavity. An opening can be formed at an arbitrary portion of the A-type spacer 51 by heat so that the filling agent can be flow out of the spacer. In the event that the battery temperature has increased under a normal use condition, heat insulation and/or heat release is performed by the A-type spacer 51, in which the filling agent is filled in the inner cavity, whereby a further increase of the battery temperature is prevented. Moreover, even when abnormal heat generation occurs in one of the plurality of cells, an opening is formed at a portion of the A-type spacer 51 by heat and the filling agent flows out of the spacer. Thereby, the inner cavity of the spacer is emptied and an air space is formed therein. By this air space, heat insulation is performed more effectively, and the abnormal heat generation is reliably prevented from spreading to other cells. Furthermore, since the filling agent has fire-extinguishing capability, the A-type spacer 51, in which the filling agent having fire-extinguishing capability is filled, can prevent spreading of the fire even if one of the plurality of cells ignites. Sill further, when this happens, the filling agent having fire-extinguishing capability flows out and scatters over the portion that has ignited, whereby the fire is extinguished.

In addition, although the A-type spacer 51 is made of plastic (PET), not metal, the A-type spacer 51 is configured to be capable of preventing spreading of fire. Thus, the A-type spacer 51 is configured to be lightweight, and the mass energy density of the battery module A1 is kept at a desired level. In addition, because the filling agent having fire-extinguishing capability is filled in the A-type spacer 51, it is unnecessary to allocate the space for the filling agent outside the A-type spacer 51. Therefore, the battery module A1 is made compact and the volumetric energy density is made large correspondingly.

Moreover, since the A-type spacer 51 is made of PET, which is a flammable plastic, the A-type spacer 51 burns when ignition occurs, allowing the filling agent therein to flow out of the spacer, so that the fire can be extinguished by the filling agent. Further, since PET, which is a general-purpose plastic, is used as the material, the A-type spacer 51 can be manufactured at low cost and at the same time good processability is ensured.

Still further, since the drip pan 33 for collecting the filling agent flowing out from the A-type spacer 51 is provided, the fire extinguishing by the filling agent is performed more effectively. Specifically, fire extinguishing is performed on the way in which the filling agent flows out of the A-type spacer 51, and moreover, the cells are immersed in the filling agent collected by the drip pan 33. Thereby, fire extinguishing is performed more reliably. Furthermore, the drip pan 33 is also configured to serve the function to prevent the filling agent that has flowed out from leaking out of the battery module A1.

On the other hand, the battery module B1 achieves the following advantageous effects, in addition to the just-described advantageous effects obtained by the battery module A1. A low-melting point portion 14 made of Bi—Cd—Pb—Sn alloy (melting point 75° C.) is formed at a portion (a lower end portion of one side edge) of the B-type spacer 52. The Bi—Cd—Pb—Sn alloy is a material having a lower melting point than the melting point of PET (about 250° C. to about 280° C.), which is the material that forms the B-type spacer 52. Therefore, if heat generation occurs in a cell and the temperature rises to about 75° C., the low-melting point portion melts, forming an opening. Through the opening, the water filled therein, which is the filling agent, flows out of the spacer. Thus, a spacer that is capable of forming an opening by heat and allowing the filling agent therein to flow out is obtained with a simple configuration, in which the low-melting point portion 14 is formed at a portion of the B-type spacer 52. In addition, the location of the low-melting point portion 14 is determined at a specific location, the location at which the filling agent flows out therethrough is restricted to be at the specific location. Thus, the filling agent is caused to flow out intensively at a desired location so that fire extinguishing can be performed reliably at the location.

### Second Example

### Preparation of Pouch-Type Container

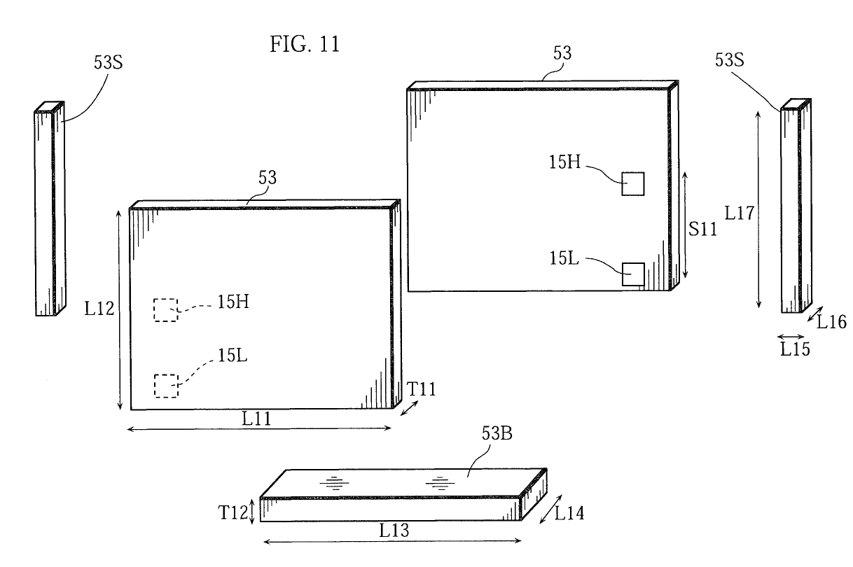

As illustrated in FIG. 11, plate materials made of polyethylene terephthalate (PET) were bonded to form a square-shaped pouch-type container. Through holes each with a diameter of about several millimeters were formed at two locations in one of the plate materials that formed one side of the pouch-type container, one location being at a lower end of the container and the other location being at a central portion thereof that is located above the lower location and spaced at a gap S11=50 mm therefrom. Next, water as liquid was filled in the pouch-type container from the just-mentioned through holes. Thereafter, a Bi—Cd—Pb—Sn alloy (with a mass ratio Bi:Cd:Pb:Sn=50:10:25:15 and a melting point of 75° C.) was formed into small pieces each with dimensions of 10 mm×10 mm×0.5 mm to form lids. The lids were bonded by adhesive so as to cover the upper and lower through holes. Thereby, two low-melting point portions 15L and 15H were formed so as to be aligned vertically. Thus, a spacer 53 (hereinafter referred to as a “C-type spacer”) in which liquid was enclosed was prepared. The spacer 53 had a width L11 of 150 mm, a height L12 of 95 mm, and a thickness T11 of 4 mm. Another set of the C-type spacer 53 was prepared, and the total number of the C-type spacer 53 prepared was two.

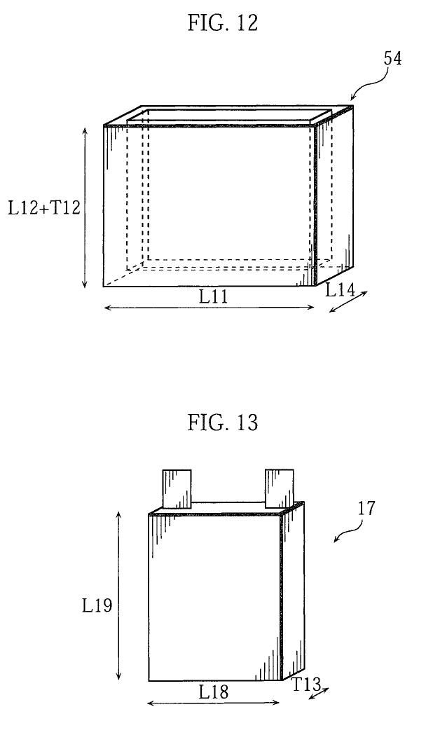

Next, the two sets of the C-type spacer 53 were opposed to each other so that the surfaces thereof on which the low-melting point portions 15L and 15H were formed face each other. Prismatic interposing materials 53S each having a length L15=4 mm, a width L16=4 mm, and a height L17=95 mm were interposed between the plate materials along both side edges of the plate materials. The C-type spacers 53 and the interposing materials 53S were overlapped with each other and placed on a bottom plate 53B having a length L13=150 mm, a width L14=12 mm, and a thickness T12=5 mm. Lastly, the C-type spacers 53, the interposing materials 53S, and the bottom plate 53B were melt-bonded together. Thus, a pouch-type container 54 with an open upper end, having a length L11=150 mm, a width L14=12 mm, a height L12+T12=100 mm was prepared, as illustrated in FIG. 12.

It should be noted that the interposing materials 53S and the bottom plate 53B are formed of a material having flexibility, specifically polytetrafluoroethylene (PTFE), so that the pouch-type container 54 can deform and the cells can be compressed sufficiently when a pressure is applied thereto during the manufacture of the battery module.

### Preparation of Cell

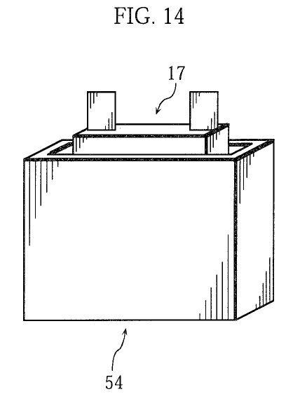

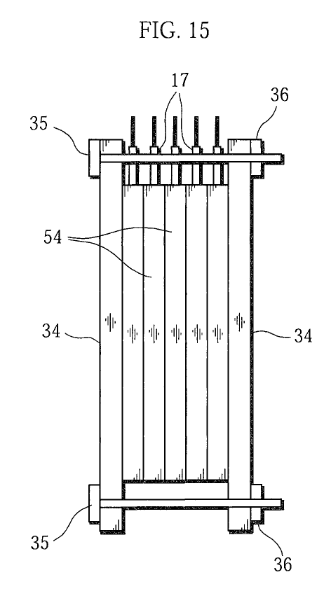

A cell 17 having a width L18 of 100 mm and a height L19 of 120 mm as illustrated in FIG. 13 was prepared according to the method described previously in the preferred embodiments of the invention. Subsequently, the cell 17 was enclosed in the above-described pouch-type container 54, as illustrated in FIG. 14.

### Preparation of Battery Module

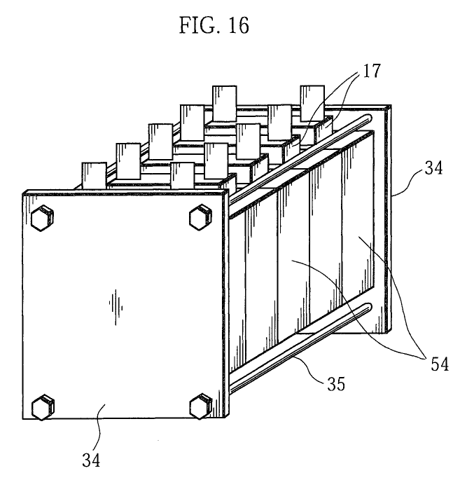

As illustrated in FIGS. 15 and 16, five sets of the pouch-type container 54 in each of which the cell 17 was placed were stacked and disposed between two pressure plates 34, and the two pressure plates 34 were fastened by bolts 35 and nuts 36. Thus, a battery module was fabricated.

The battery module fabricated in this manner is hereinafter referred to as a battery module C1.

### Advantageous Effects of Battery Module

The battery module C1 has the same advantageous effects as obtained by the battery modules A1 and B1 of the first example, and it additionally exhibits the following advantageous effects. That is, the C-type spacer 53 has flexibility such that it can shrink when in a compressed state, which is common to the cases of the foregoing battery modules A1 and B1. Therefore, when an opening forms in the C-type spacer 53, it shrinks by the pressure so as to squeeze out the filling agent therefrom, allowing the filling agent to flow out therefrom effectively. In addition, the shrinkage of the C-type spacer causes crease-like surface irregularities to form in the surface thereof, and the surface irregularities can serve the function similar to ribs, making the fire extinguishing more efficient. Moreover, because the C-type spacers 53 constitute portions (obverse and reverse sides) of the pouch-type container 54 in which the cell 17 can be placed, the pouch-type container 54 can also serve as a drip pan for collecting the filling agent flowing out of the spacer. Thereby, fire extinguishing is performed more effectively. More specifically, the filling agent that has flowed out of the C-type spacer 53 is reserved in the interior of the pouch-type container 54, so the cells are immersed in the reserved filling agent more reliably, whereby fire extinguishing is performed more effectively.

Furthermore, since every one of the plurality of cells 17 is placed in the corresponding one of the C-type spacers 54, the filling agent flowing out of the spacer does not scatter randomly but is collected to the corresponding one of the C-type spacers 54 exclusively. As a result, the filling agent accumulates to a further higher position in the C-type spacer 54 (i.e., more effectively), allowing the cells 17 to be immersed in the filling agent reliably.

In addition, the low-melting point portions 15L and 15H are formed at a plurality of locations having different height positions (the upper and lower two locations). Therefore, the upper low-melting point portion 15H allows the filling agent filled at a position higher than that to flow outside therethrough and flow downward, whereby the primary fire extinguishing process (initial stage fire-extinguishing) is performed at the portion lower than the upper low-melting point portion 15H. Subsequently, the lower low-melting point portion 15L allows the remaining filling agent to flow outside, whereby the secondary fire extinguishing process is performed. Thus, the filling agent is allowed to flow out at a plurality of height positions in performing the fire extinguishing, so the fire extinguishing can be performed more effectively.

In particular, it is believed that abnormal heat generation or ignition occurs most easily at a central portion of the battery. Accordingly, by forming the upper low-melting point portion 15H at the central portion, the filling agent can flow out to the central portion, and the fire extinguishing can be performed more efficiently.

It should be noted that in this case, the filling agent can be allowed to flow out successively from the upper low-melting point portion by setting the melting point of the upper low-melting point portion 15H to be lower than that of the lower low-melting point portion 15L.

### Third Example

### Preparation of Heat Conductive Material (Sheet)

A thermal conductive gel sheet (available from Geltec Corp. under the trade name of Lambda Gel COH-4000) having a thickness 1 mm was cut into a rectangular shape with a width of 100 mm and a height of 120 mm to form a sheet-shaped heat conductive material. The just-mentioned thermal conductive gel sheet (Lambda Gel COH-4000) is a sheet-shaped thermal conductive gel made of silicone, and it has a thermal conductivity of 6.5 W/m·K.

### Preparation of Cell

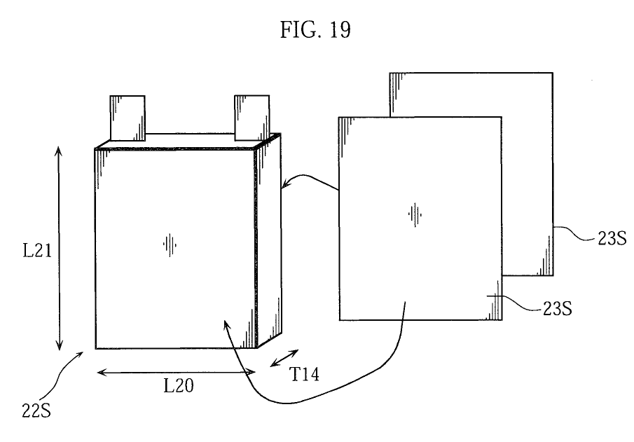

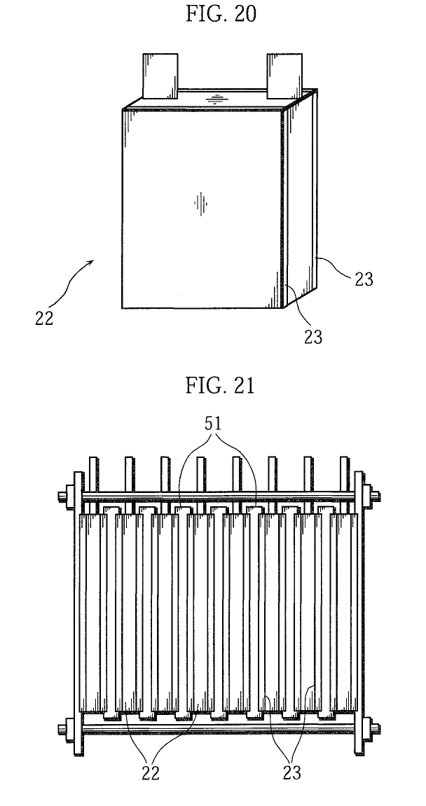

As illustrated in FIG. 19, a cell 22S (width L20=100 mm, height L21=120 mm, thickness T14=4 mm), which had the same configuration as the cells 17 used for the battery module C1 of the second example, was prepared, and the sheet-shaped heat conductive material 23S was bonded on both sides of the cell 22S. Thus, a cell 22 (battery) in which heat conductive material layers 23, 23 were formed on both sides was obtained, as illustrated in FIG. 20. Eight sets of the cell 22 were prepared.

### Preparation of Battery Module

A battery module was fabricated in the same manner as the battery module A1 of Example A1 above, except for using the eight sets of the cell 22. Thus, a battery module as illustrated in FIG. 21 was obtained, in which seven spacers 51 and eight cells 22 are alternately disposed and the heat conductive material layers 23 are respectively formed between the spacers 51 and the cells 22.

The battery module fabricated in this manner is hereinafter referred to as a battery module D1.

### Advantageous Effects of Battery

Each of the cells 22 that forms the battery module D1 may be used alone as a single-cell battery. The cell 22 is configured to be a secondary battery enclosed in a battery case made of a laminate film, i.e., a battery case having flexibility, wherein a heat conductive material layer 23 made of a gel material is formed on a surface of the battery case. This configuration promotes heat release from the battery and thereby hinders deterioration of the secondary battery resulting from temperature increase.

The battery is enclosed in a battery case having flexibility, made of a laminate film. Although the surface of the battery case tends to be damaged easily by scratches or the like caused by mechanical impacts during shipping, use, handling and the like of the battery, provision of the heat conductive material layer 23 serves to protect the battery from the mechanical impacts or the like and prevent the damages.

In addition, because the heat conductive material layer 23 is formed of a gel material, the heat conductive material layer 23 has good adhesion with the battery, and accordingly, the air space does not form easily. As a result, heat conduction from the battery becomes more effective, and the heat dissipation capability further improves. In addition, the battery is protected from mechanical impacts or the like more reliably. Furthermore, since the battery is enclosed in a battery case having flexibility, the battery tends to easily deform when handling, and in addition, the battery deforms to a certain degree due to the volumetric change resulting from the charge-discharge operations. However, because the heat conductive material layer 23 is formed of a gel material, it can change the shape correspondingly to such deformation of the battery. Therefore, the heat conductive material layer 23 can be formed easily, and at the same time, cracks resulting from the battery deformation can be prevented.

Since the heat conductive material layer 23 is made of a gel sheet 23S, handling becomes easy, and the heat conductive material layer can be formed by merely attaching the sheet onto the surface of the battery case. As a result, the workability in the process of fabricating the battery module is improved. In particular, the sheet-shaped heat conductive material 23S (Lambda Gel COH-4000) has tacking capability and therefore can be attached simply to the surface of the cell 22S.

In addition, the heat conductive material layer 23 is configured to comprise silicone as its main component. Since the materials comprising silicone as the main component has good heat conductivity and are also available easily and at low cost, a heat conductive material layer 23 having good heat conductivity can be formed easily and at low cost.

Moreover, the thermal conductivity of the heat conductive material layer 23 is 6.5 W/m·K. This means that heat conduction is performed sufficiently by the heat conductive material layer 23, and the heat dissipation effect is enhanced. Furthermore, the thermal conductivity is not at a higher level than is necessary and the material is available easily; therefore, it is within the range in which the heat conductive material layer 23 can be easily formed.

In addition, the thickness of the heat conductive material layer 23 is set at 1 mm. This means that the thickness of the heat conductive material layer 23 is not excessively small, so the characteristics thereof such as heat conductivity and impact resistance are sufficient. At the same time, the heat conductive material layer 23 does not occupy an excessively large space, degradation in the volumetric energy density of the battery is suppressed. Also, the risk of the heat conductivity degradation resulting from an excessively great thickness of the heat conductive material layer 23 is avoided.

### Advantageous Effects of Battery Module

In the configuration of the battery module D1, heat conduction from the cell 22 to the spacer 51 is promoted and heat release is performed more efficiently since the heat conductive material layer 23 is interposed between the spacer 51 and the cell 22. Thereby, the battery deterioration resulting from temperature increase is prevented.

Since the cell 22 is enclosed in a battery case made of a laminate film and having flexibility, the surface of the battery case tends to be damaged easily during the assembling process of the battery module D1 by scratches or the like caused by, for example, mechanical impacts associated with the assembling process. However, since the above-described heat conductive material layer 23 is formed, the cell 22 is protected from the mechanical impacts or the like and is prevented from the damages.

Since the heat conductive material layer 23 is formed of a gel material, the heat conductive material layer 23 is provided with good adhesion with the spacer 51 and the cell 22S, and therefore, the air space does not form easily. As a result, heat conduction becomes more effective, and the heat dissipation capability further improves. In addition, the cell 22S is protected more reliably from mechanical impacts or the like. Furthermore, since the cell 22S is enclosed in the battery case having flexibility, which is made of a laminate film, the cell 22S tends to easily deform when handling, and in addition, the cell 22S deforms to a certain degree due to the volumetric change resulting from the charge-discharge operations. However, because the heat conductive material layer 23 is formed of a gel material, it can change the shape correspondingly to such deformation of the cell 22S. Therefore, the heat conductive material layer 23 can be formed easily, and at the same time, cracks resulting from the battery deformation can be prevented.

Since the heat conductive material layer 23 is made of the gel sheet 23S, handling becomes easy, and the heat conductive material layer 23 can be formed by merely inserting the sheet between the spacer 51 and the cell 22S (in the present example, the sheets are attached to both sides of each of the cells 22S). As a result, the workability in the process of fabricating the battery module D1 is also improved. In particular, the sheet-shaped heat conductive material 23S (Lambda Gel COH-4000) has tacking capability and therefore can be attached simply to the surfaces of the cells 22S.

In addition, the heat conductive material layer 23 is configured to comprise silicone as its main component. Since the materials comprising silicone as the main component has good heat conductivity and are also available easily and at low cost, a heat conductive material layer 23 having good heat conductivity can be formed easily and at low cost.

Moreover, the thermal conductivity of the heat conductive material layer 23 is 6.5 W/m·K. This means that heat conduction is performed sufficiently by the heat conductive material layer 23, and the heat dissipation effect is enhanced. Furthermore, the thermal conductivity is not at a higher level than is necessary and the material is available easily; therefore, it is within the range in which the heat conductive material layer 23 can be easily formed.

In addition, the thickness of the heat conductive material layer 23 is set at 1 mm. This means that the thickness of the heat conductive material layer 23 is not excessively small, so the characteristics thereof such as heat conductivity and impact resistance are sufficient. At the same time, the heat conductive material layer 23 does not occupy an excessively large space, degradation in the volumetric energy density of the battery module D1 is suppressed. Also, the risk of the heat conductivity degradation resulting from an excessively great thickness of the heat conductive material layer 23 is avoided.

### Fourth Example

### Preparation of Battery Module

A battery module was fabricated in the same manner as described in the second example, except for using the cells 22 (batteries) prepared according to the third example, in which heat conductive material layers 23, 23 were formed on both sides, in place of using the cells 17 of the second example.

The battery module fabricated in this manner is hereinafter referred to as a battery module E1.

### Advantageous Effects of Battery Module

The battery module E1 uses the cells 22 (batteries) in which the heat conductive material layers 23, 23 are formed on both sides thereof. Therefore, it has the same advantageous effects as obtained by the battery module D1 of the third example. Moreover, the battery module E1 exhibits the same advantageous effects as obtained by the battery module C1 of the second example since each of the cells 22 is enclosed in the pouch-type container 54 in which portions thereof (both sides) are formed of the C-type spacers 53.

More specifically, the C-type spacers 53 constitute portions (obverse and reverse sides) of the pouch-type container 54, in which each of the cells 22 can be placed. Therefore, the filling agent that has flowed out of the C-type spacer 53 is reserved in the interior of the pouch-type container 54, so the cells 22 are immersed in the reserved filling agent more reliably, whereby fire extinguishing is performed more effectively.

Furthermore, since every one of the plurality of cells 22 is placed in the corresponding one of the C-type spacers 54, the filling agent flowing out of the spacer does not scatter randomly but is collected to the corresponding one of the C-type spacers 54 exclusively. As a result, the filling agent accumulates to a further higher position in the C-type spacer 54 (i.e., more effectively), allowing the cells 22 to be immersed in the filling agent reliably.

In addition, the low-melting point portions 15L and 15H are formed at a plurality of locations having different height positions (the upper and lower two locations). Therefore, the upper low-melting point portion 15H allows the filling agent filled at a position higher than that to flow outside therethrough and flow downward, whereby the primary fire extinguishing process (initial stage fire-extinguishing) is performed at the portion lower than the upper low-melting point portion 15H. Subsequently, the lower low-melting point portion 15L allows the remaining filling agent to flow outside, whereby the secondary fire extinguishing process is performed. Thus, the filling agent is allowed to flow out at a plurality of height positions in performing the fire extinguishing, so the fire extinguishing can be performed more effectively. In particular, since the upper low-melting point portion 15H is formed at the central portion of the battery, which is believed to be the location where abnormal heat generation or ignition occurs most easily, the configuration allows the filling agent to flow out to the central portion to perform the fire extinguishing more efficiently.

### Other Embodiments

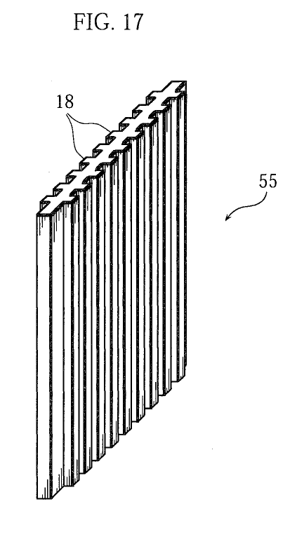

(1) It is possible to provide ribs extending vertically on a surface of the spacer that is in contact with a battery. FIG. 17 is a view illustrating an example of the spacer on which ribs are formed. A plurality of ribs 18 extending vertically in parallel are formed at regular intervals on the observe and reverse sides, which are to be in contact with the batteries, of a spacer 55. In this configuration, gaps are formed along both sides of each rib 18, and the gaps serve as the passages for the filling agent, allowing the filling agent to flow downward more reliably. Moreover, the gaps serve as heat dissipation paths in the event that heat generation occurs in a battery, whereby heat release is performed more effectively. In particular, since batteries are in contact with both surfaces of the spacer, the filling agent can flow downward more easily and heat release is also more effective when the batteries are in contact with the spacer with the ribs formed thereon than when both surfaces of the spacer are flat and smooth and the spacer and the batteries are in close contact with each other entirely.

In the example shown in FIG. 17, low-melting point portions (not shown) are provided in a plurality of gaps among a multiplicity of gaps formed between a multiplicity of ribs 18. However, it is possible that such low-melting point portions may not be provided, and that an opening may be formed at an arbitrary location in the entirety of the spacer 55 by heat.

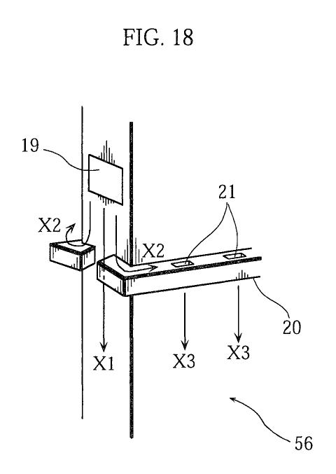

(2) It is possible to provide ribs extending horizontally on a surface of the spacer. This allows the filling agent to be guided in horizontal directions as well as in a downward direction, permitting the filling agent to spread over a wider area. As a result, fire extinguishing can be performed more effectively. In particular, when a spacer 56 has such a configuration in which the filling agent flows out from a low-melting point portion 19 provided in a side edge portion of the spacer, as illustrated in FIG. 18, the filling agent flows downward along the side edge portion of the spacer 56, as indicated by the arrow X1. In this case, by providing ribs 20 that extend horizontally to both sides adjacent to the side edge portion, the filling agent is guided by the ribs 20, as indicated by the arrow X2, and is allowed to spread on both sides of the spacer 56. In the example shown in FIG. 18, the ribs 20 are formed to extend from the side edge portion of the spacer 56 so as to slope downwardly along both sides so that the filling agent can flow more smoothly on the ribs 20. In addition, holes 21 that penetrate the ribs vertically are formed in the ribs 20 at appropriate intervals, whereby the filling agent flows downward at appropriate locations, as indicated by the arrows X3, and spreads over a wide area on both sides of the spacer 56.

(3) Examples of the usable filling agent include baking soda (sodium acid carbonate: NaHCO₃), in addition to ammonium dihydrogen phosphate (NH₄H₂PO₄) and water mentioned above.

It should be noted from the viewpoint of preventing internal short circuits more reliably that it is desirable that the filling agent have also insulative capability.

(4) The low-melting point portion may also be provided at other locations than in the obverse and/or reverse sides and in the side edge portion of the spacer, such as in a bottom portion. In addition, it is also possible to provide low-melting point portions at a plurality of locations at horizontal intervals so that the filling agent can flow out so as to be scattered over a wider area.

(5) It is also possible to enclose the filling agent in the spacer in a compressed state along with a gas such as a nitrogen gas so that it can be ejected outside by the pressure when an opening is formed in the spacer, whereby the efficiency in fire extinguishing is increased further.

(6) The spacer may be configured to have rigidity to such a degree that it can retain the initial shape even when undergoing substantially the same or higher level as the pressure applied, for example, during the fabrication of the battery module. Alternatively, the spacer may have rigidity or flexibility less than the foregoing level. When the filling agent in the spacer flows out of the spacer, an air space forms and a heat insulation effect is exhibited. In the case that the spacer has such rigidity, the capacity of the air space is retained reliably by the rigidity of the spacer. In addition, since the spacer retains the shape, the spacer does not lose its original function to keep a gap between batteries (cells). On the other hand, in the case that the spacer is flexible, the spacer can shrink by the pressure when an opening forms in the spacer so as to squeeze out the filling agent therefrom, allowing the filling agent to flow out therefrom effectively. Moreover, since the spacer shrinks correspondingly to the outflow of the filling agent, a gap may be formed, in some cases, outside the spacer corresponding to the shrinkage, and the gap may exhibit a heat insulation effect. In addition, the shrinkage of the spacer may produce crease-like surface irregularities, and the surface irregularities can serve the function similar to that of the above-described ribs and grooves.

(7) The positive electrode active material is not limited to lithium cobalt oxide. Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.

(8) Other than graphite such as natural graphite and artificial graphite, various materials may be employed as the negative electrode active material, as long as the material is capable of intercalating and deintercalating lithium ions. Examples include coke, tin oxides, metallic lithium, silicon, and mixtures thereof.

(9) The electrolyte is not limited to that shown in the examples above, and various other substances may be used. Examples of the lithium salt include LiBF₄, LiPF₆, LiN(SO₂CF₃)₂, LiN(SO₂C₂F₅)₂, and LiPF_{6-X}(CₙF₂ₙ₊₁)x (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte. The types of the solvents are not particularly limited to EC and MEC mentioned above, and examples of the preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

(10) The type of the power-generating element is not limited to the stacked type element, and it is of course possible to use an oblong type power-generating element, which is obtained by compressing a spirally-wound power-generating element. The type of the battery is not limited to the non-aqueous electrolyte battery but may be an alkaline battery and the like.

(11) When the heat conductive material layer is provided in the battery module, as in the third and the fourth embodiments, it is possible to use any other type of spacer in place of the spacer of the present invention in which a filling agent having fire-extinguishing capability is filled in the inner cavity. In this case as well, the heat dissipation effect can be improved by the heat conductive material layer. However, it should be noted, of course, that the use of the spacer according to the present invention in combination with the heat conductive material layer improves the safety and volumetric energy density of the battery module.

(12) The heat conductive material layer may be formed by applying, for example, a paste made of a gel material to the surfaces of the spacer and/or the battery, as described above. An example of such thermal conductive gel in a paste form is Lambda Gel DP (trademark of Geltec Corp.).

The present invention is suitably applied to, for example, power sources for high-power applications, such as power sources for motive power that are incorporated in robots and electric automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A battery module comprising:
a plurality of batteries connected in series or in parallel, and at least one spacer, for heat insulation and/or heat release, interposed between the plurality of batteries; and
a filling agent filled in an inner cavity provided in the at least one spacer, the filling agent having fire-extinguishing capability, wherein
an opening can be formed in at least a portion of the at least one spacer by heat so that the filling agent can flow out therethrough.

2. The battery module according to claim 1, wherein the at least one spacer is made of a flammable plastic.

3. The battery module according to claim 1, wherein a portion of the at least one spacer has at least one low-melting point portion made of a material having a melting point lower than a melting point of a material that constitutes the at least one spacer.

4. The battery module according to claim 1, wherein the at least one low-melting point portion is a plurality of low-melting point portions, and the plurality of low-melting point portions are formed at a plurality of locations located at different height positions.

5. The battery module according to claim 1, further comprising a drip pan for collecting the filling agent flowing out from the at least one spacer.

6. The battery module according to claim 5, wherein the drip pan is divided into a plurality of sections.

7. The battery module according to claim 1, wherein the at least one spacer comprises ribs extending vertically and formed on a surface of the at least one spacer that is in contact with one of the plurality of batteries.

8. The battery module according to claim 1, wherein the at least one spacer has flexibility such that it can shrink when in a compressed state, and the at least one spacer forms at least a portion of a pouch-type container in which one of the plurality of batteries is placed.

9. The battery module according to claim 1, further comprising a heat conductive material layer formed between the at least one spacer and at least one of the plurality of batteries.

10. The battery module according to claim 9, wherein the heat conductive material layer comprises a gel material.

11. The battery module according to claim 10, wherein the heat conductive material layer is formed of a gel sheet.

12. The battery module according to claim 9, wherein the heat conductive material layer comprises silicone.

13. The battery module according to claim 9, wherein the heat conductive material layer has a thermal conductivity of from 6 W/m·K to 10 W/m·K.

14. The battery module according to claim 9, wherein the heat conductive material layer has a thickness of from 0.5 mm to 3 mm.

15. A battery module comprising:
a plurality of batteries connected in series or in parallel, and at least one spacer, for heat insulation and/or heat release, interposed between the plurality of batteries; and
a heat conductive material layer formed between the at least one spacer and at least one of the plurality of batteries.

16. The battery module according to claim 15, wherein the heat conductive material layer comprises a gel material.

17. The battery module according to claim 16, wherein the heat conductive material layer is formed of a gel sheet.

18. The battery module according to claim 15, wherein the heat conductive material layer comprises silicone.

19. The battery module according to claim 15, wherein the heat conductive material layer has a thermal conductivity of from 6 W/m·K to 10 W/m·K.

20. The battery module according to claim 15, wherein the heat conductive material layer has a thickness of from 0.5 mm to 3 mm.
